(19) United States
(12) Patent Application Publication
(10) Pub. No.: US 2018/0217674 A1
(43) Pub. Date: Aug. 2, 2018

(54) STROKE INPUT METHOD, DEVICE AND SYSTEM

(71) Applicant: BEIJING QIHOO TECHNOLOGY COMPANY LIMITED, BEIJING (CN)

(72) Inventor: QIANG GAO, BEIJING (CN)

(73) Assignee: BEIJING QIHOO TECHNOLOGY COMPANY LIMITED, BEIJING (CN)

(21) Appl. No.: 15/537,624

(22) PCT Filed: Nov. 17, 2015
(86) PCT No.: PCT/CN2015/094840

§ 371 Date: Jun. 19, 2017

(30) Foreign Application Priority Data
Dec. 19, 2014 (CN) 2014108023675

(51) Int. Cl. G06F 3/01; G06F 3/023

(52) U.S. Cl. CPC G06F 3/018; G06F 3/0233

(57) ABSTRACT

The disclosure discloses a stroke input method, and relates to the technical field of input methods. The method comprises: in a stroke input mode, receiving a stroke sequence inputted by a user; performing various segmentation operations on the stroke sequence to obtain various stroke paths; with respect to each stroke path, calculating an index grouping number corresponding to the stroke path according to index codes and corresponding word orders respectively corresponding to respective strokes; according to the index grouping number, performing matching for the stroke path with respective words stored under the index grouping number in a lexicon, and using matched words as on-screen candidate items; wherein, the respective words in the lexicon are stored under corresponding index grouping numbers according to index grouping numbers to which the words belong that are calculated according to index codes corresponding to strokes of the respective words.

### CROSS-REFERENCE TO RELATED APPLICATIONS

This application is the national stage of International Application No. PCT/CN2015/094840 filed Nov. 17, 2015, which is based upon and claims priority to Chinese Patent Application No. CN201410802367.5, filed Dec. 19, 2014, the entire contents of all of which are incorporated herein by reference.

### TECHNICAL FIELD

The disclosure relates to the technical field of input methods, and particularly to a stroke input method, a stroke input device and a stroke input system.

### BACKGROUND

In various computer devices, default input languages are characters in English. Input of English can be performed by directly selecting letters. However, input of other languages is more troublesome; for example in Chinese language there are tens of thousands of characters, making it impossible to directly perform input simply through keys and making it necessary to perform coding on Chinese characters, for example to perform coding (corresponding to a stroke input method) on Chinese characters according to font characteristics (e.g. strokes) of the Chinese characters, etc., in order to perform input. With respect to other characters which similarly have stroke structures, there also exists a case of performing coding according to the stroke structures to perform character input.

However, taking stroke input of Chinese characters as an example, in the traditional stroke input, a word cannot be directly inputted without inputting a separator or clicking a segmentation button in the process of inputting a stroke sequence; for example if “ [symbol] ” is inputted, candidates “ [symbol] ”, “ [symbol] . . . ” appear, and only single characters appear in the appearing candidates. If it is necessary to input a phrase in a stroke sequence, it is necessary for a user to initiatively input a separator or click a segmentation button in the process of inputting the stroke sequence, so as to realize segmentation of the stroke sequence into multiple words to perform matching; for example, only when a user inputs “ [symbol] ’ [symbol] ”, that is, inputs an additional segmentation symbol “’” in the input string, word candidates such as “ [symbol] ” and so on will appear in the result. Although this manner increases the accuracy of words desired to appear by the user, it increases a key input number of the user.

### SUMMARY

In view of the above defect, the disclosure is proposed to provide a stroke input device and a corresponding stroke input method to overcome the above defect or at least partially solve the above defect.

According to one aspect of the disclosure, there is provided a stroke input method, comprising:

in a stroke input mode, receiving a stroke sequence inputted by a user;

performing various segmentation operations on the stroke sequence to obtain various stroke paths;

with respect to each stroke path, calculating an index grouping number corresponding to the stroke path according to index codes and corresponding word orders respectively corresponding to respective strokes; and

according to the index grouping number, performing matching for the stroke path with respective words stored under the index grouping number in a lexicon, and using matched words as on-screen candidate items; wherein, the respective words in the lexicon are stored under corresponding index grouping numbers according to index grouping numbers to which the words belong that are calculated according to index codes corresponding to strokes of the respective words.

According to one aspect of the disclosure, there is provided a stroke input device, comprising:

one or more processors; and

a memory;

wherein one or more programs are stored in the memory, and when executed by the one or more processors, the one or more programs cause the one or more processors to:

in a stroke input mode, receive stroke sequence inputted by a user;

perform various segmentation operations on the stroke sequence to obtain various stroke paths;

with respect to each stroke path, calculate an index grouping number corresponding to the stroke path according to index codes and corresponding word orders respectively corresponding to respective strokes; and

according to the index grouping number, perform matching for the stroke path with respective words stored under the index grouping number in a lexicon, and use matched words as on-screen candidate items; wherein, the respective words in the lexicon are stored under corresponding index grouping numbers according to index grouping numbers to which the words belong that are calculated according to index codes corresponding to strokes of the respective words.

The disclosure further discloses a stroke input system, which specifically may comprise:

a cloud server and a client;

the client comprising:

a stroke sequence receiving module adapted to, in a stroke input mode, receive stroke sequence inputted by a user;

a stroke sequence uploading module adapted to upload the stroke sequence to the cloud server;

a candidate item generation module adapted to use received words as on-screen candidate items;

the cloud server comprising:

a lexicon grouping module adapted to store the respective words in the lexicon under corresponding index grouping numbers according to index grouping numbers to which the words belong that are calculated according to index codes corresponding to strokes of the respective word;

a stroke sequence segmentation module adapted to perform various segmentation operations on the stroke sequence to obtain various stroke paths;

a stroke index grouping calculation module adapted to, with respect to each stroke path, calculate an index grouping number corresponding to the stroke path according to index codes and corresponding word orders respectively corresponding to respective strokes;

a stroke path matching module adapted to, according to the index grouping number, perform matching for the stroke path with respective words stored under the index grouping number in a lexicon, and return matched words to the client.

According to another aspect of the disclosure, there is provided a computer program comprising computer-readable code that, when run on a terminal equipment, causes the terminal equipment to perform any of the above stroke input methods.

According to yet another aspect of the disclosure, there is provided a computer-readable medium having a computer program for performing any one of the above stroke input methods stored thereon.

In accordance with one stroke input method according to the disclosure, it is made possible to implement the process of inputting a phrase to a stroke sequence inputted directly by a user, without requiring the user to input a separator or click a segmentation button, when the user inputs the stroke sequence using a stroke input mode. In the above process, the respective words in the lexicon are stored under corresponding index grouping numbers according to index grouping numbers to which the words belong that are calculated according to index codes corresponding to strokes of the respective words; then various segmentation operations are automatically performed on the stroke sequence inputted by the user, for example, “ [symbol] ” can be segmented into three stroke paths, i.e. “ [symbol] ’ [symbol] ” [symbol] “ [symbol] ’ [symbol] ” [symbol] “ [symbol] ”, and with respect to each stroke path, an index grouping number corresponding to the stroke path is calculated according to index codes and corresponding word orders respectively corresponding to respective strokes, thereby making it possible to perform matching for the stroke path with respective words under the index grouping number in a lexicon, thus making it possible to obtain on-screen candidate words. In this way, it is made possible to solve the problem that if it is necessary to input a phrase in a stroke sequence, it is necessary for a user to initiatively input a separator or click a segmentation button in the process of inputting the stroke sequence, while producing the following advantageous effect: without greatly reducing the accuracy of words selected by the user, corresponding words are returned for user selection directly according to the stroke sequence inputted by the user, making it possible to reduce a key-pressing number of the user and greatly increase an input speed of the user.

The above descriptions are only a summary of the technical solution of the disclosure. To enable the technical means of the disclosure to be understood more clearly, it may be implemented according to the contents of the description, and to enable the above and other objects, features and advantages of the disclosure to be more apparent and pellucid, detailed embodiments of the disclosure are hereby provided below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the present invention. And in the whole drawings, same drawing reference signs are used for representing same components. In the drawings:

FIG. 1 shows a schematic view of the flow of a stroke input method according to one embodiment of the disclosure;

FIG. 2 shows a schematic view of the flow of a stroke input method according to one embodiment of the disclosure;

FIG. 3 shows a schematic view of the flow of a stroke input method according to one embodiment of the disclosure;

FIG. 4 shows a schematic view of the flow of a stroke input method according to one embodiment of the disclosure;

FIG. 5 shows a schematic view of the structure of a stroke input device according to one embodiment of the disclosure;

FIG. 6 shows a schematic view of the structure of a stroke input device according to one embodiment of the disclosure;

FIG. 7 shows a schematic view of the structure of a stroke input device according to one embodiment of the disclosure;

FIG. 8 shows a schematic view of the structure of a stroke input system according to one embodiment of the disclosure;

FIG. 9 shows a block diagram of a terminal equipment for performing the method according to the disclosure;

FIG. 10 shows a storage unit for retaining or carrying a program code for implementing the method according to the disclosure.

### DETAILED DESCRIPTION

Hereinafter, exemplary embodiments of the disclosure will be described in more details with reference to the drawings. Although the drawings show the exemplary embodiments of the disclosure, it should be understood that the disclosure can be carried out in various forms without being limited by the embodiments described herein. On the contrary, these embodiments are provided to enable more thorough understanding to the disclosure and to enable the scope of the disclosure to be fully reached by those skilled in the art.

One of the core concepts of the disclosure is: the respective words in the lexicon are stored under corresponding index grouping numbers according to index grouping numbers to which the words belong that are calculated according to index codes corresponding to strokes of the respective words; then various segmentation operations are automatically performed on the stroke sequence inputted by the user, for example, “ [symbol] ” can be segmented into three stroke paths, i.e. “ [symbol] ’ [symbol] ” [symbol] “ [symbol] ’ [symbol] ” [symbol] “ [symbol] ”, and with respect to each stroke path, an index grouping number corresponding to the stroke path is calculated according to index codes and corresponding word orders respectively corresponding to respective strokes, thereby making it possible to perform matching for the stroke path with respective words under the index grouping number in a lexicon, thus making it possible to obtain on-screen candidate words. In this way, it is made possible to solve the problem that if it is necessary to input a phrase in a stroke sequence, it is necessary for a user to initiatively input a separator or click a segmentation button in the process of inputting the stroke sequence, and to produce the following advantageous effect: without greatly reducing the accuracy of words selected by the user, corresponding words are returned for user selection directly according to the stroke sequence inputted by the user, making it possible to greatly increase an input speed of the user.

### Embodiment I

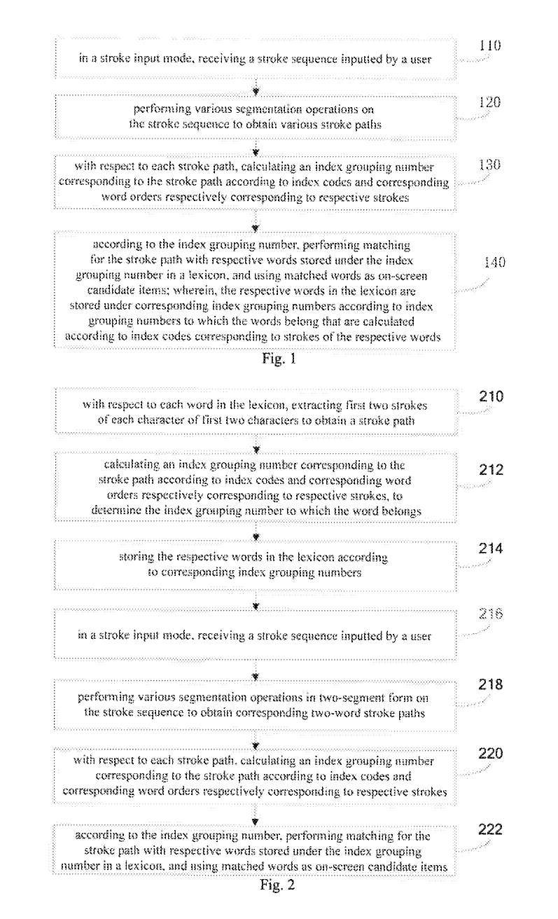

Referring to FIG. 1, FIG. 1 shows a schematic view of the flow of a stroke input method according to the disclosure.

In the embodiment of the disclosure, a lexicon can be adjusted in advance, namely by:

a step 100 of storing respective words in the lexicon under corresponding index grouping numbers according to index grouping numbers to which the words belong that are calculated according to index codes corresponding to strokes of the respective words.

For example there are 10000 words in the lexicon. With respect to the respective strokes in the stroke input mode, index coding can be performed on the respective strokes; for example with respect to horizontal, vertical, left-falling, right-falling and turning, for example “ [symbol] ”, each stroke respectively corresponds to index codes 1, 2, 3, 4, 5. Then with respect to the words in the lexicon, index grouping numbers where the words lie can be calculated from index codes corresponding to strokes of the respective characters of the words according to a predetermined grouping function, and then the above 10000 words are stored in groups. For example if the above 10000 words are divided into 1000 groups, each group possibly includes about 10 words in average. Then, a user can enter a shortcut stroke input process based on the above lexicon, which specifically comprises:

Step 110 of, in a stroke input mode, receiving a stroke sequence inputted by a user.

In the embodiment of the disclosure, a user shall enter a stroke input mode to perform text input with a stroke keyboard. For example a user uses a nine-key stroke input method, in which for example a nine-key keyboard is as follows: key 1 corresponds to: [symbol] , key 2 corresponds to: [symbol] , key 3 corresponds to: [symbol] , Key 4 corresponds to: [symbol] , Key 5 corresponds to: [symbol] , key 6 corresponds to: wildcard, and keys 7, 8, 9 correspond to others.

Then the user can input a stroke sequence, e.g. “ [symbol] ”, by clicking keys.

Step 120 of performing various segmentation operations on the stroke sequence to obtain various stroke paths.

Upon receipt of the stroke sequence “ [symbol] ” inputted by the user, various possible segmentation operations can be performed on the stroke sequence to obtain various stroke paths, and respective segments of a stroke sub-sequence of each stroke path correspondingly matches with one character. Taking a stroke path segmented into two characters as an example, the aforesaid “ [symbol] ” can be segmented into cases such as “ [symbol] ’ [symbol] ” [symbol] “ [symbol] ” [symbol] “ [symbol] ’ [symbol] ” [symbol] “ [symbol] ’ [symbol] ’ [symbol] ” and so on. In “ [symbol] ’ [symbol] ”, “ [symbol] ” matches with a stroke sequence of the first character in the words, and “ [symbol] ” matches with a stroke sequence of the second character in the words. Reasoning by analogy from the above example applies to other cases.

Step 130 of, with respect to each stroke path, calculating an index grouping number corresponding to the stroke path according to index codes and corresponding word orders respectively corresponding to respective strokes.

For example index codes respectively corresponding to the aforesaid “ [symbol] ” are “12345”. Then with respect to the stroke path “ [symbol] ’ [symbol] ” in the aforesaid example, a index code corresponding to each stroke of the stroke path is 1, 2, 1, 1, wherein “ [symbol] ’ corresponds to the first character, then the first 1 corresponds to the first character, “ [symbol] ” corresponds to the second character, then the subsequent “211” corresponds to the second character, that is, 1211 can be segmented into “1” and “211”. Then a grouping index number where the stroke path “ [symbol] ’ [symbol] ” lies can be calculated according to “1” and “211’.

Step 140 of, according to the index grouping number, performing matching for the stroke path with respective words stored under the index grouping number in a lexicon, and using matched words as on-screen candidate items; wherein, the respective words in the lexicon are stored under corresponding index grouping numbers according to index grouping numbers to which the words belong that are calculated according to index codes corresponding to strokes of the respective words.

After an index grouping number of one stroke path is obtained through calculation, respective words stored under corresponding index grouping numbers can be looked up in the lexicon according to the index grouping number, so as to perform matching for the stroke path with the respective words. For example with respect to the aforesaid “ [symbol] ’ [symbol] ”, for each word under this index grouping number, “ [symbol] ” is matched with the first character of the word, and “ [symbol] ” is matched with the second character of the word. Upon matching of the both, it may be regarded that they are matching, and the word can be used as an on-screen candidate item.

The lookup and matching process for other stroke paths is similar to the above process. In this way, respective words corresponding to the stroke sequence inputted by the user can be obtained.

Of course, in the embodiment of the disclosure, with respect to the stroke sequence inputted by the user, it is also possible to match single words according to the stroke sequence and also use the matched single words as on-screen candidate items.

Then respective presentation positions are adjusted according to presentation weights (parameters such as a word frequency and so on) of the respective matched words and characters.

The embodiment of the disclosure stores the words in the lexicon in groups. When performing grouping for the words, index grouping numbers to which the words belong are calculated according to index codes corresponding to strokes of the respective words, to store the words under the index grouping numbers. Then various segmentation operations can be automatically performed on the stroke sequence inputted by the user to obtain various stroke paths; then with respect to each stroke path, an index grouping number corresponding to the stroke path can be calculated according to index codes and corresponding word orders respectively corresponding to respective strokes, to perform matching for corresponding words in corresponding groups. In the above process, it is unnecessary for a user to input a separator or click a segmentation button in the process of inputting the stroke sequence, such that without greatly reducing the accuracy of words selected by the user, corresponding words are returned for user selection directly according to the stroke sequence inputted by the user, making it possible to greatly increase an input speed of the user.

### Embodiment II

Referring to FIG. 2, FIG. 2 shows a schematic view of the flow of a stroke input method according to the disclosure, which specifically may comprise:

Step 210 of, with respect to each word in the lexicon, extracting first two strokes of each character of first two characters to obtain a stroke path.

In the embodiment of the disclosure, stored structures of words in an input method lexicon are adjusted. At the time of the adjusting, first two characters of each word as well as first two strokes of each character are extracted first, to obtain a four-stroke stroke sequence.

Step 212 of calculating an index grouping number corresponding to the stroke path according to index codes and corresponding word orders respectively corresponding to respective strokes, to determine the index grouping number to which the word belongs.

For example with respect to strokes “horizontal, vertical, left-falling, right-falling and turning”, for example “ [symbol] ”, in the input method, each stroke respectively corresponds to index codes 1, 2, 3, 4, 5. Then a corresponding index code can be obtained for the aforesaid four-stroke stroke sequence, such that an index grouping number corresponding to the stroke path can be calculated according to the index codes, to determine the index grouping number to which the word belongs.

Of course, the strokes in the stroke input mode in the embodiment of the disclosure can further include other forms. Preferably, the strokes are horizontal, vertical, left-falling, right-falling and turning, for example the aforesaid “ [symbol] ”.

Preferably, the following is further comprised.

Step 208 of selecting continuous N nonzero integers in one-to-one correspondence to respective strokes in the stroke input mode, as index codes of respective strokes.

For example, in the stroke input mode there are five strokes, for example the aforesaid horizontal, vertical, left-falling, right-falling and turning, then index codes corresponding to each stroke may be 1, 2, 3, 4, 5 in order, and of course may also be 5, 4, 3, 2, 1. The disclosure does not make limitations to the specific one-to-one correspondence between each stroke and the continuous N nonzero integers.

Preferably, the index codes are numerical symbols corresponding to keys where the strokes lie.

For example, a nine-key keyboard is as follows: key 1 corresponds to: [symbol] , key 2 corresponds to: [symbol] , key 3 corresponds to: [symbol] , Key 4 corresponds to: [symbol] , Key 5 corresponds to: [symbol] , key 6 corresponds to: wildcard, and keys 7, 8, 9 correspond to others. Then a index code of “ [symbol] ” corresponds to 1, a index code of “ [symbol] ” corresponds to 2, a index code of) “ [symbol] ” corresponds to 3, a index code of “ [symbol] ” corresponds to 4, and a index code of “ [symbol] ” corresponds to 5.

Step 214 of storing the respective words in the lexicon according to corresponding index grouping numbers.

Then, the respective words in the lexicon can be stored in groups according to the index grouping numbers. In the disclosure, after storage in groups is performed with the aforesaid four strokes, that is, words and characters are stored using a 4-level index grouping structure, a total number of the groups of the words as obtained is substantially:

5¹+5²+5³+5⁴=780

After storage in groups is performed with respect to the words in the input method lexicon through the aforesaid steps, it is made possible to enter the flow of receiving a user's stroke input.

Step 216 of, in a stroke input mode, receiving a stroke sequence inputted by the user.

in an operation device, for example in a device of a smart phone, the user triggers startup of the input method to switch to the stroke input mode, i.e., to switch to the stroke keyboard, such as the above nine-key keyboard that is as follows: key 1 corresponds to: [symbol] , key 2 corresponds to: [symbol] , key 3 corresponds to: [symbol] , Key 4 corresponds to: [symbol] , Keys 5 corresponds to: [symbol] , key 6 corresponds to: wildcard, and keys 7, 8, 9 correspond to others.

Then by clicking the keys in the stroke keyboard, the user can obtain a stroke sequence, for example the user inputs “ [symbol] ”.

Step 218 of performing various segmentation operations in two-segment form on the stroke sequence to obtain corresponding two-word stroke paths.

That is, the stroke sequence inputted by the user is segmented into various two-segment stroke paths, but will not be segmented into three-segment or more-segment stroke paths. For example with respect to the aforesaid “ [symbol] ”, only various possible two-segment segmentation are performed, to obtain only three kinds of two-segment stroke paths “ [symbol] ’ [symbol] ” [symbol] “ [symbol] ’ [symbol] ” [symbol] “ [symbol] ”, wherein each segment of a stroke sequence in each stroke path corresponds to one character in a word; for example in “ [symbol] ’ [symbol] ”, “ [symbol] ” is used for matching a stroke sequence of the first character in a certain word stored in a corresponding index grouping number in subsequent steps, and “ [symbol] ” is used for matching a stroke sequence of the second character in a certain word in subsequent steps.

Step 220 of, with respect to each stroke path, calculating an index grouping number corresponding to the stroke path according to index codes and corresponding word orders respectively corresponding to respective strokes.

With respect to the above various stroke paths obtained, for example the aforesaid three stroke paths “ [symbol] ’ [symbol] ” [symbol] “ [symbol] ’ [symbol] ” [symbol] “ [symbol] ’ [symbol] ”, taking “ [symbol] ’ [symbol] ” as an example, a index code corresponding to each stroke of the stroke path is 1211, wherein “ [symbol] ’ corresponds to the first character, then the first 1 corresponds to the first character, “ [symbol] ” corresponds to the second character, then the subsequent “211” corresponds to the second character, that is, 1211 can be segmented into “1” and “211”. Then, according to the substitution of “1” and “211” into a predetermined grouping function, the grouping index number where the stroke path “ [symbol] ’ [symbol] ” lies can be calculated.

Step 222 of, according to the index grouping number, performing matching for the stroke path with respective words stored under the index grouping number in a lexicon, and using matched words as on-screen candidate items.

Then with respect to the aforesaid “ [symbol] ’ [symbol] ”, after the index grouping number where it lies is determined, matching can be performed for the “ [symbol] ’ [symbol] ” with respective words stored under the index grouping number in the lexicon, wherein, the preceding segment “ [symbol] ” is matched with the first character in the word, and the subsequent segment “ [symbol] ” is matched with the second character of the word. Upon matching of the both, it may be regarded that they are matching, and the word can be used as an on-screen candidate item.

The lookup and matching process for other stroke paths is similar to the above process. In this way, respective words corresponding to the stroke sequence inputted by the user can be obtained.

Preferably, the following is further comprised:

a step 224 of, with respect to the matched words, according to word frequencies of the words, adjusting presentation weights of the words when being used as the on-screen candidate items.

In the embodiment of the disclosure, multiple words will be obtained through matching in the respective index grouping numbers, and a display position of a screen is limited, so the words used as the on-screen candidate items shall be made to comply with the user's habits more accurately, such that the user can select vocabularies more rapidly. Thus, according to word frequencies of the respective words which are counted in advance, presentation weights of the words when being used as the on-screen candidate items can be adjusted, such that those with high word frequencies are displayed at anterior positions in order while those with low word frequencies are displayed at subsequent positions in order.

Preferably, the following is further comprised:

a step 226 of recording personalized words of a user and, according to the recording, adjusting presentation weights of the words when being used as the on-screen candidate items.

Different users possibly will often use some non-popular words, so by counting click frequencies or in other words use frequencies of all the words, the above rarely-used words used by the user are possibly low-frequency words. If the presentation weights of the words when being used as the on-screen candidate items are also adjusted in the manner in the step 224, they will be arranged at subsequent positions in order, which however fails to comply with the habits of the user using the words. To overcome the above case, the embodiment of the disclosure will record the number of times of selection of the stroke sequence inputted by the user in association with the words used as the on-screen candidate items; for example if the number of times of selecting “ [symbol] ” after inputting “ [symbol] ” is greater than a threshold, when the user inputs the “ [symbol] ”, a presentation weight of “ [symbol] ” is increased, such that it is displayed at an first position in order.

Of course, in the embodiment of the disclosure, with respect to the stroke sequence inputted by the user, it is also possible to match single words according to the stroke sequence and also use the matched single words as on-screen candidate items.

Then, respective presentation positions are adjusted according to presentation weights (parameters such as a word frequency and so on) of the respective matched words and characters.

In the embodiment of the disclosure, in the disclosure after storage in groups is performed with the aforesaid four strokes, that is, words and characters are stored using a 4-level index grouping structure, a total number of the groups of the words as obtained is substantially: 5¹+5²+5³+5⁴=780. In this way, after grouping for data in the lexicon is performed, the number of words desired to be matched which are inputted per time will greatly decrease, making it possible to greatly increase a program running speed. Assuming that 10000 commonly used words are stored in the lexicon, without use of the above grouping, according to the traditional matching manner, a stroke sequence inputted by the user each time will be matched 10000 times; while with use of the grouping scheme of the disclosure, there are only 10000÷780=12.82 words under each group in average, per time of input there will probably be about 10 groups to be searched, per time of input the number of matched words decrease from 10000 to 128.2, and time consumption caused by word matching drops by 98.7%, thus greatly reducing the number of times of matching, solving the problem in regard to performances of words freely segmented from strokes at a mobile terminal, improving an operation speed, and making it possible to complete the presentation of the on-screen candidate items in a case where the use essentially cannot perceive a calculation delay. In addition, in the above process, it is unnecessary for a user to input a separator or click a segmentation button in the process of inputting the stroke sequence, such that without greatly reducing the accuracy of words selected by the user, corresponding words are returned for user selection directly according to the stroke sequence inputted by the user, making it possible to greatly increase an input speed of the user.

### Embodiment III

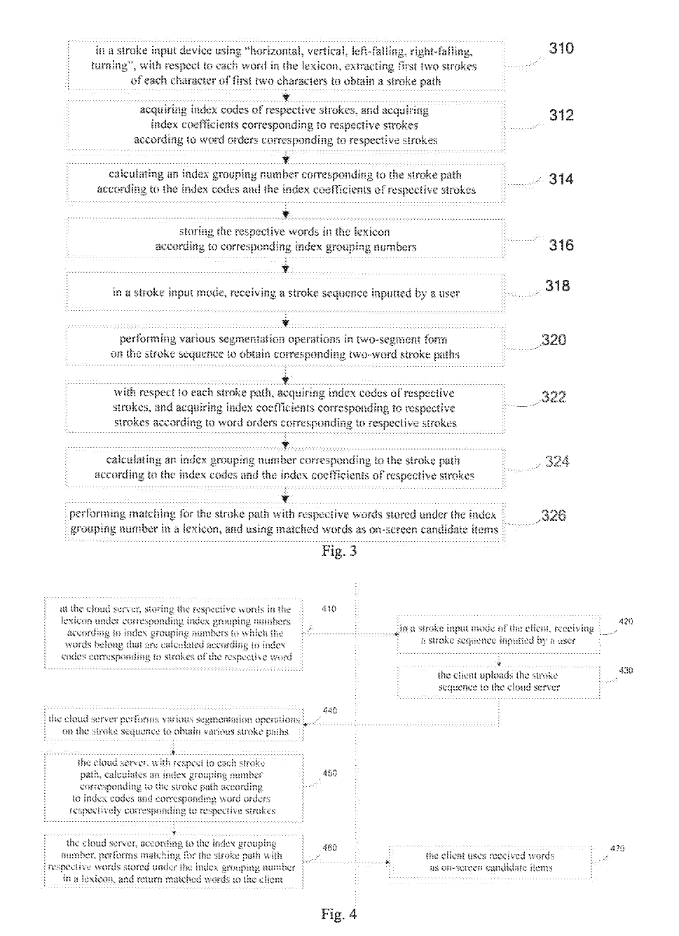

Referring to FIG. 3, FIG. 3 shows a schematic view of the flow of a preferable stroke input method according to the disclosure, which specifically may comprise as follows.

Step 310 of, in a stroke input device using “horizontal, vertical, left-falling, right-falling, turning”, with respect to each word in the lexicon, extracting first two strokes of each character of first two characters to obtain a stroke path.

In the embodiment of the disclosure, with respect to the strokes of “horizontal, vertical, left-falling, right-falling, turning”, a nine-key keyboard which is similarly as follows is used: key 1 corresponds to: [symbol] , key 2 corresponds to: [symbol] , key 3 corresponds to: [symbol] , Key 4 corresponds to: [symbol] , Key 5 corresponds to: [symbol] , key 6 corresponds to: wildcard, and keys 7, 8, 9 correspond to others.

For example with respect to the word “ [symbol] ” first two stroke inputs corresponding to first two characters are “ [symbol] ” and “ [symbol] ” respectively, then it is obtained that a stroke path is “ [symbol] ”.

Step 312 of acquiring index codes of respective strokes, and acquiring index coefficients corresponding to respective strokes according to word orders corresponding to respective strokes.

As stated previously, a index code of “ [symbol] ” corresponds to 1, a index code of “ [symbol] ” corresponds to 2, a index code of “ [symbol] ” corresponds to 3, a index code of “ [symbol] ” corresponds to 4, and a index code of “ [symbol] ” corresponds to 5.

In the embodiment of the disclosure, in a case where an index group is constructed with first two strokes of each character of first two characters of a word, that is, words and characters are stored using a 4-level index grouping structure, a total number of the groups of the words is: 5¹+5²+5³+5⁴=780. On the basis of the 4-level index grouping structure, with respect to the aforesaid four strokes, a grouping function for calculating index grouping numbers according to strokes codes is f(x)=x₁*5⁰+x₂*5¹+x₃*5²+x₄*5³, wherein x₁ and x₂ correspond to index codes of first two strokes of the first character, and x₃ and x₄ correspond to index codes of first two strokes of the second character. If there are no strokes, x₁=0, and all the third stroke and strokes thereafter have no index coefficients and do not enter calculation.

Then with respect to the first two strokes “ [symbol] ” and “ [symbol] ” of each character in the aforesaid word “ [symbol] ” corresponding strokes codes are “12” and “11”, index coefficients corresponding to the index codes in “12” are 5⁰ and 5¹ respectively, and index coefficients corresponding to the index codes in “11” are 5² and 5³ respectively.

Also for example with respect to “ [symbol] ”, the first character “ [symbol] ” only has one stroke, with its corresponding index code being “1”, and index codes corresponding to the first two strokes of the second character “ [symbol] ” correspond to “34”, then a index code of “1” is 5⁰, and index coefficients corresponding to the index codes in “34” are 5² and 5³ respectively. In this case x₂=0 in the second item in f(x).

Step 314 of calculating an index grouping number corresponding to the stroke path according to the index codes and the index coefficients of respective strokes.

Then with respect to the first two strokes “ [symbol] ” and “ [symbol] ” of each character of the aforesaid word “ [symbol] ”, corresponding index codes are “12” and “11”, which are substituted into the aforesaid f(x)=1*5⁰+2*5¹+1*5²+1*5³, so as to obtain through calculation that the index grouping number is 161. By analogy, with respect to “ [symbol] ”, its “1 and “34” are substituted into the aforesaid f(x)=1*5⁰+0*5¹+3*5²+4*5³, so as to obtain that its index grouping number is 576. Through such construction, index grouping numbers of “ [symbol] ” and “ [symbol] ” are also 576.

Step 316 of storing the respective words in the lexicon according to corresponding index grouping numbers.

Then, the respective words can be stored in groups according to the index grouping numbers thereof.

Hereinafter, the stroke input process is introduced by way of exemplary Table I of storage in groups.

TABLE I

Grouping Index Number

| | 1 | 2 | 36 | 161 | 176 | 576 |
|---|---|---|---|---|---|---|
| Words in | [symbol] | [symbol] | [symbol] | [symbol] | [symbol] | [symbol] |
| groups | | [symbol] | [symbol] | [symbol] | [symbol] | [symbol] |
| | | | [symbol] | [symbol] | [symbol] | [symbol] |
| | | | [symbol] | [symbol] | [symbol] | [symbol] |

Step 318 of, in a stroke input mode, receiving a stroke sequence inputted by a user.

The user can perform stroke input after switching to similarly a nine-key keyboard as follows in the input method: key 1 corresponds to: [symbol] , key 2 corresponds to: [symbol] , key 3 corresponds to: [symbol] , Key 4 corresponds to: [symbol] , Key 5 corresponds to: [symbol] , key 6 corresponds to: wildcard, and keys 7, 8, 9 correspond to others. The input method according to the disclosure can receive inputted stroke sequences through the keyboard.

For example, the user inputs four strokes “ [symbol] ”.

Step 320 of performing various segmentation operations in two-segment form on the stroke sequence to obtain corresponding two-word stroke paths.

The embodiment of the disclosure first performs various segmentation operations in two-segment form on four strokes, “ [symbol] ” so as to obtain three stroke paths “ [symbol] ’ [symbol] ” [symbol] “ [symbol] ’ [symbol] ” [symbol] “ [symbol] ”. Two-segment stroke sequences of each stroke path correspond to the first character and the second character respectively.

Step 322 of, with respect to each stroke path, acquiring index codes of respective strokes, and acquiring index coefficients corresponding to respective strokes according to word orders corresponding to respective strokes.

For example, stroke serial numbers of “ [symbol] ’ [symbol] ” are “1” and “211”, and only the first two strokes are extracted for “211”, so only “21” are extracted finally. Then based on the first character corresponding to “1”, its index coefficient in f(x) is 5⁰, and based on “21”, corresponding index coefficients are 5² and 5³ respectively.

Similarly, with respect to “ [symbol] ”, a index code of “ [symbol] ” is “12”, with corresponding index coefficients being 5⁰ and 5¹, and a index code of “ [symbol] ” is “11”, with corresponding index coefficients being 5² and 5³.

With respect to “ [symbol] ”, a index code of “ [symbol] ” is “12”, with corresponding index coefficients being 5⁰ and 5¹, and a index code of “ [symbol] ” is “1”, with corresponding index coefficients being 5².

Step 324 of calculating an index grouping number corresponding to the stroke path according to the index codes and the index coefficients of respective strokes.

Then with respect to “ [symbol] ’ [symbol] ”, it is calculated from the aforesaid f(x)=1*5⁰+0*5¹+2*5²+1*5³ that its index grouping number f(x) is 176. Similarly, with respect to “ [symbol] ”, f(x)=1*5⁰+2*5¹+1*5²+1*5³=161, and with respect to “ [symbol] ”, f(x)=1*5⁰+2*5¹+*5²+0*5³=36.

Step 326 of, according to the index grouping number, performing matching for the stroke path with respective words stored under the index grouping number in a lexicon, and using matched words as on-screen candidate items.

Then with respect to “ [symbol] ’ [symbol] ” matching of respective words can be performed under the index grouping number 176 in Table 1, to obtain words such as “ [symbol] ”, “ [symbol] ” and the like. With respect to “ [symbol] ”, matching of respective words can be performed under the index grouping number 161 in Table 1, to obtain words such as “ [symbol] [symbol] ”, “ [symbol] ”, “ [symbol] ”, “ [symbol] ” and the like. With respect to “ [symbol] ”, matching of respective words can be performed under the index grouping number 36 in Table 1, to obtain words such as “ [symbol] ”, “ [symbol] ”, “ [symbol] ” and the like.

Of course, in the embodiment of the disclosure, with respect to the words such as “ [symbol] [symbol] ”, “ [symbol] ”, “ [symbol] ” and the like, only the first two characters can be matched while it is impossible to fully match all characters, so these words may not be used as on-screen candidate items.

Preferably, the following is further comprised:

a step 328 of, with respect to the matched words, according to word frequencies of the words, adjusting presentation weights of the words when being used as the on-screen candidate items.

In the embodiment of the disclosure, multiple words will be obtained through matching in the respective index grouping numbers, and a display position of a screen is limited, so the words used as the on-screen candidate items shall be made to comply with the user's habits more accurately, such that the user can select vocabularies more rapidly. Thus, according to word frequencies of the respective words which are counted in advance, presentation weights of the words when being used as the on-screen candidate items can be adjusted, such that those with high word frequencies are displayed at anterior positions in order while those with low word frequencies are displayed at subsequent positions in order.

Preferably, the following is further comprised:

a step 330 of recording personalized words of a user and, according to the recording, adjusting presentation weights of the words when being used as the on-screen candidate items.

Different users possibly will often use some non-popular words, so by counting click frequencies or in other words use frequencies of all the words, the above rarely-used words used by the user are possibly low-frequency words. If the presentation weights of the words when being used as the on-screen candidate items are also adjusted in the manner in the step 224, they will be arranged at subsequent positions in order, which however fails to comply with the habits of the user using the words. To overcome the above case, the embodiment of the disclosure will record the number of times of selection of the stroke sequence inputted by the user in association with the words used as the on-screen candidate items; for example if the number of times of selecting “ [symbol] ” after inputting “ [symbol] ” is greater than a threshold, when the user inputs the “ [symbol] ”, a presentation weight of “ [symbol] ” is increased, such that it is displayed at an first position in order.

Of course, in the embodiment of the disclosure, with respect to the stroke sequence inputted by the user, it is also possible to match single words according to the stroke sequence and also use the matched single words as on-screen candidate items.

Then, respective presentation positions are adjusted according to presentation weights (parameters such as a word frequency and so on) of the respective matched words and characters.

In the embodiment of the disclosure, the lexicon in which storage in groups is performed can either be stored locally at a client or be stored at a cloud server. When the lexicon is stored at the cloud server, the input method can locally perform the aforesaid segmentation operation and calculation process with respect to the stroke sequence, to obtain a corresponding index grouping number; then words stored in a corresponding index grouping number which can match with a corresponding stroke path are acquired from the lexicon at the cloud server, and the words are used as on-screen candidate items of the client input method; the input method can also upload the stroke sequence to the cloud server, perform the aforesaid segmentation operation and calculation process with respect to the stroke sequence at the cloud serer, to obtain a corresponding index grouping number, and then the words stored in the corresponding index grouping number which can match with a corresponding stroke path that are acquired from the lexicon at the cloud server are returned to the client, and the client use the words as on-screen candidate items of the client input method.

For the user, what is the most important for the input method is input efficiency, which is considered substantially in terms of the following two aspects: an input speed, and input accuracy. As discovered through bulk analysis on user inputs, a small number of high-frequency words in a lexicon in a device can cover most of stroke inputs of the user, so giving candidate words reasonably by free segmentation will not greatly reduce the accuracy of words selected by the user but can greatly increase the input speed of the user, wherein low-frequency words that are often used by the user can assist in the solution by recording user words.

The largest difficulty in inputting strokes by stroke automatic segmentation is the problem of program efficiency. Since segmentation can be arbitrary, it is necessary to search for all possible stroke paths and use these stroke paths to match words. Assuming that the maximum length of the words in the lexicon is 4, time complexity in the worst case is O(n)=n̂4C(dict), where n is an input length, and C(dict) is the capacity of the lexicon. If this manner is adopted to search for candidate words, on a mobile terminal (for example a mobilephone) due to limitations by hardware thereof, the search process is time-consuming and intolerable, such that the interface will be jammed to death. If search time consumption is reduced by trimming the capacity of the lexicon, a reduction in the accuracy of appearing words will arise, while the effect is also not ideal. In the embodiment of the disclosure, after storage in groups is performed with the aforesaid four strokes, that is, words and characters are stored using a 4-level index grouping structure, the number of words desired to be matched which are inputted per time will greatly decrease, making it possible to greatly increase a program running speed. Assuming that 10000 commonly used words are stored in the lexicon, without use of the above grouping, according to the traditional matching manner, a stroke sequence inputted by the user each time will be matched 10000 times; while with use of the grouping scheme of the disclosure, there are only 10000÷780=12.82 words under each group in average, per time of input there will probably be about 10 groups to be searched, per time of input the number of matched words decrease from 10000 to 128.2, and time consumption caused by word matching drops by 98.7%, thus greatly reducing the number of times of matching, solving the problem in regard to performances of appearing words by freely segmenting from strokes at a mobile terminal, improving an operation speed, and making it possible to complete the presentation of the on-screen candidate items in a case where the use essentially cannot perceive a calculation delay.

In addition, in the above process, it is unnecessary for a user to input a separator or click a segmentation button in the process of inputting the stroke sequence, such that without greatly reducing the accuracy of words selected by the user, corresponding words are returned for user selection directly according to the stroke sequence inputted by the user, making it possible to greatly increase an input speed of the user. Furthermore, by analyzing user data, it is found that probabilities of inputting words with 2-4 characters by the stroke user are 34.80%, 15.45% and 8.96% respectively. Assuming that the stroke user inputs 4 strokes in each word in average, since a segmentation symbol will be saved between two characters, embodiments of the disclosure can reduce the number of key inputs by 13.23% for the user, improving the input efficiency of the user.

### Embodiment IV

Referring to FIG. 4, FIG. 4 shows a schematic view of the flow of a preferable stroke input method according to the disclosure, which specifically may comprise:

a step 410 of, at the cloud server, storing the respective words in the lexicon under corresponding index grouping numbers according to index grouping numbers to which the words belong that are calculated according to index codes corresponding to strokes of the respective word;

In the embodiment of the disclosure, this step is performed at the cloud server, and the created lexicon is also stored at the cloud server.

a step 420 of, in a stroke input mode of the client, receiving a stroke sequence inputted by a user;

a step 430 in which the client uploads the stroke sequence to the cloud server;

a step 440 in which the cloud server performs various segmentation operations on the stroke sequence to obtain various stroke paths;

a step 450 in which the cloud server, with respect to each stroke path, calculate an index grouping number corresponding to the stroke path according to index codes and corresponding word orders respectively corresponding to respective strokes;

a step 460 in which the cloud server, according to the index grouping number, performs matching for the stroke path with respective words stored under the index grouping number in a lexicon, and return matched words to the client; and

a step 470 in which the client uses received words as on-screen candidate items.

Of course, in the embodiment of the disclosure, the client input method can also locally analyze respective index grouping numbers corresponding to a stroke sequence, and then upload the index grouping numbers and the corresponding stroke path to the cloud server, and the cloud server performs matching for the words in the lexicon according to the index grouping numbers and then returns the words to the client input method.

In the embodiment of the disclosure, in combination with the cloud server, the words in the lexicon are stored in groups at the cloud serve. When performing grouping for the words, index grouping numbers to which the words belong are calculated according to index codes corresponding to strokes of the respective words, to store the words under the index grouping numbers. Then with respect to the stroke sequence inputted by the user which is received in the client input method, various segmentation operations can be automatically performed in combination with the cloud server, to obtain various paths; then with respect to each stroke path, an index grouping number corresponding to the stroke path can be calculated according to index codes and corresponding word orders respectively corresponding to respective strokes, to perform matching for corresponding words in corresponding groups. In the above process, it is unnecessary for a user to input a separator or click a segmentation button in the process of inputting the stroke sequence, such that without greatly reducing the accuracy of words selected by the user, corresponding words are returned for user selection directly according to the stroke sequence inputted by the user, making it possible to greatly increase an input speed of the user.

### Embodiment V

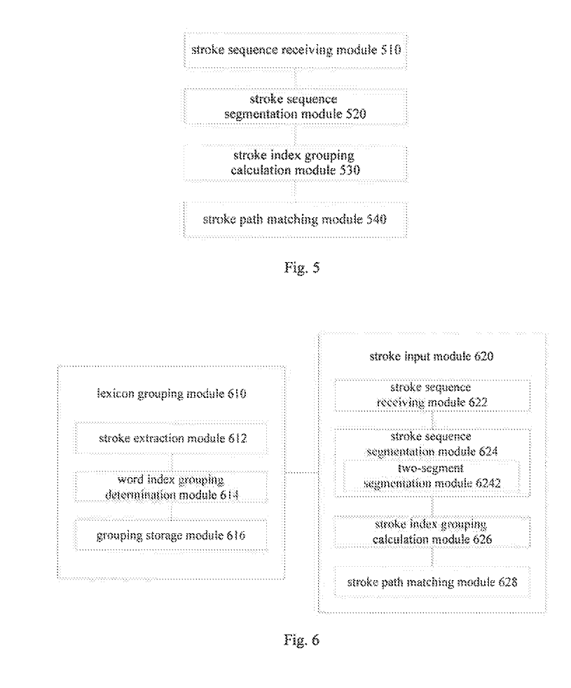

Referring to FIG. 5, FIG. 5 shows a schematic view of the structure of a preferable stroke input device according to the disclosure, which specifically may comprise:

a stroke sequence receiving module 510 adapted to, in a stroke input mode, receive stroke sequence inputted by a user;

a stroke sequence segmentation module 520 adapted to perform various segmentation operations on the stroke sequence to obtain various stroke paths;

a stroke index grouping calculation module 530 adapted to, with respect to each stroke path, calculate an index grouping number corresponding to the stroke path according to index codes and corresponding word orders respectively corresponding to respective strokes;

a stroke path matching module 540 adapted to, according to the index grouping number, perform matching for the stroke path with respective words stored under the index grouping number in a lexicon, and use matched words as on-screen candidate items; wherein, the respective words in the lexicon are stored under corresponding index grouping numbers according to index grouping numbers to which the words belong that are calculated according to index codes corresponding to strokes of the respective words.

### Embodiment VI

Referring to FIG. 6, FIG. 6 shows a schematic view of the structure of a preferable stroke input device according to the disclosure, which specifically may comprise:

a lexicon grouping module 610 adapted to store the respective words in the lexicon under corresponding index grouping numbers according to index grouping numbers to which the words belong that are calculated according to index codes corresponding to strokes of the respective word; specifically comprising:

a stroke extraction module 612 adapted to, with respect to each word in the lexicon, extract first two strokes of each character of first two characters to obtain a stroke path;

a word index grouping determination module 614 adapted to calculate an index grouping number corresponding to the stroke path according to index codes and corresponding word orders respectively corresponding to respective strokes, to determine the index grouping number to which the word belongs;

a grouping storage module 616 adapted to store the respective words in the lexicon according to corresponding index grouping numbers.

A stroke input module 620, comprising:

a stroke sequence receiving module 622 adapted to, in a stroke input mode, receive stroke sequence inputted by a user;

a stroke sequence segmentation module 624, comprising:

a two-segment segmentation module 6241 adapted to perform various segmentation operations in two-segment form on the stroke sequence to obtain corresponding two-word stroke paths;

a stroke index grouping calculation module 626 adapted to, with respect to each stroke path, calculate an index grouping number corresponding to the stroke path according to index codes and corresponding word orders respectively corresponding to respective strokes;

a stroke path matching module 628 adapted to, according to the index grouping number, perform matching for the stroke path with respective words stored under the index grouping number in a lexicon, and use matched words as on-screen candidate items.

Preferably, the stroke sequence segmentation module comprises:

a two-segment segmentation module adapted to perform various segmentation operations in two-segment form on the stroke sequence to obtain corresponding two-word stroke paths.

Preferably, the stroke index grouping calculation module or the word index grouping determination module comprises:

a parameter extraction module adapted to acquire index codes of respective strokes, and to acquire index coefficients corresponding to respective strokes according to word orders corresponding to respective strokes;

a grouping number calculation module adapted to calculate an index grouping number corresponding to the stroke path according to the index codes and the index coefficients of respective strokes.

Preferably, strokes in the stork input mode comprise: horizontal, vertical, left-falling, right-falling, turning.

Preferably, the following is further comprised: a index code determination module adapted to select continuous N nonzero integers in one-to-one correspondence to respective strokes in the stroke input mode, as index codes of respective strokes.

Preferably, the index codes are numerical symbols corresponding to keys where the strokes lie.

Preferably, the index coefficients are determined from a stroke number N and an index level number of the stroke input mode.

Preferably, the following is further comprised: a word weight adjustment module adapted to, with respect to the matched words, according to word frequencies of the words, adjust presentation weights of the words when being used as the on-screen candidate items.

Preferably, the following is further comprised: a personalized word weight adjustment module adapted to record personalized words of a user and, according to the recording, to adjust presentation weights of the words when being used as the on-screen candidate items.

### Embodiment VII

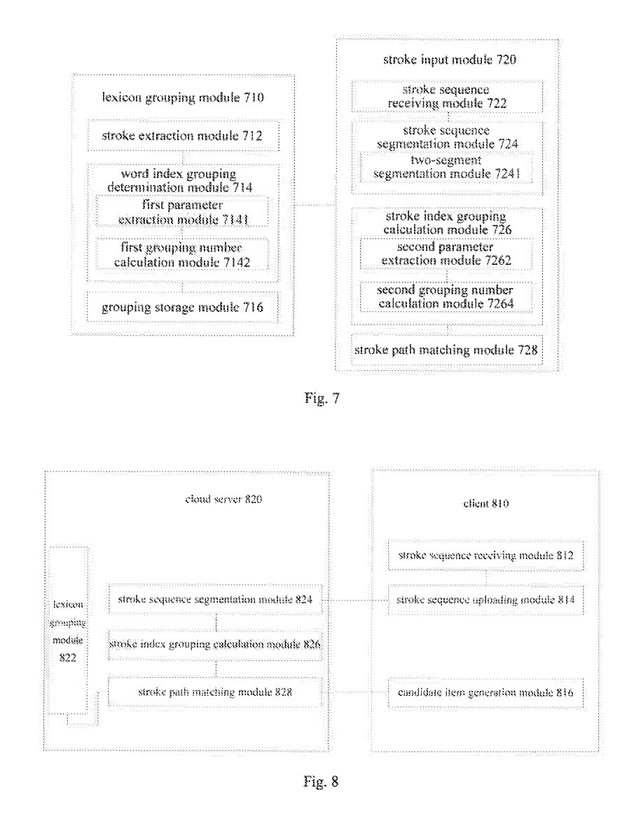

Referring to FIG. 7, FIG. 7 shows a schematic view of the structure of a preferable stroke input device according to the disclosure, which specifically may comprise:

a lexicon grouping module 710 adapted to, in a stroke input device using “horizontal, vertical, left-falling, right-falling, turning”, storing the respective words in the lexicon under corresponding index grouping numbers according to index grouping numbers to which the words belong that are calculated according to index codes corresponding to strokes of the respective words; which specifically comprise comprises:

a stroke extraction module 712 adapted to, with respect to each word in the lexicon, extracting first two strokes of each character of first two characters to obtain a stroke path;

a word index grouping determination module 714, comprising:

a first parameter extraction module 7141 adapted to acquire index codes of respective strokes, and to acquire index coefficients corresponding to respective strokes according to word orders corresponding to respective strokes;

a first grouping number calculation module 7142 adapted to calculate an index grouping number corresponding to the stroke path according to the index codes and the index coefficients of respective strokes;

a grouping storage module 716 adapted to store the respective words in the lexicon according to corresponding index grouping numbers.

A stroke input module 720, comprising:

a stroke sequence receiving module 722 adapted to, in a stroke input mode, receive stroke sequence inputted by a user;

a stroke sequence segmentation module 724, comprising:

a two-segment segmentation module 7241 adapted to perform various segmentation operations in two-segment form on the stroke sequence to obtain corresponding two-word stroke paths;

a stroke index grouping calculation module 726, comprising:

a second parameter extraction module 7261 adapted to acquire index codes of respective strokes, and to acquire index coefficients corresponding to respective strokes according to word orders corresponding to respective strokes;

a second grouping number calculation module 7262 adapted to calculate an index grouping number corresponding to the stroke path according to the index codes and the index coefficients of respective strokes;

a stroke path matching module 728 adapted to, according to the index grouping number, perform matching for the stroke path with respective words stored under the index grouping number in a lexicon, and use matched words as on-screen candidate items.

### Embodiment VIII

Referring to FIG. 8, FIG. 8 shows a schematic view of the structure of a preferable stroke input system according to the disclosure, which specifically may comprise:

a cloud server 820 and a client 810;

the client 810 comprising:

a stroke sequence receiving module 812 adapted to, in a stroke input mode, receive stroke sequence inputted by a user;

a stroke sequence uploading module 814 adapted to upload the stroke sequence to the cloud server;

a candidate item generation module 816 adapted to use received words as on-screen candidate items;

the cloud server 820 comprising:

a lexicon grouping module 822 adapted to store the respective words in the lexicon under corresponding index grouping numbers according to index grouping numbers to which the words belong that are calculated according to index codes corresponding to strokes of the respective word;

a stroke sequence segmentation module 824 adapted to perform various segmentation operations on the stroke sequence to obtain various stroke paths;

a stroke index grouping calculation module 826 adapted to, with respect to each stroke path, calculate an index grouping number corresponding to the stroke path according to index codes and corresponding word orders respectively corresponding to respective strokes;

a stroke path matching module 828 adapted to, according to the index grouping number, perform matching for the stroke path with respective words stored under the index grouping number in a lexicon, and return matched words to the client.

Preferably, the lexicon grouping module comprises:

a stroke extraction module adapted to, with respect to each word in the lexicon, extract first two strokes of each character of first two characters to obtain a stroke path;

a word index grouping determination module adapted to calculate an index grouping number corresponding to the stroke path according to index codes and corresponding word orders respectively corresponding to respective strokes, to determine the index grouping number to which the word belongs;

a grouping storage module adapted to store the respective words in the lexicon according to corresponding index grouping numbers.

Preferably, the stroke sequence segmentation module comprises:

a two-segment segmentation module adapted to perform various segmentation operations in two-segment form on the stroke sequence to obtain corresponding two-word stroke paths.

Preferably, the stroke index grouping calculation module or the word index grouping determination module comprises:

a parameter extraction module adapted to acquire index codes of respective strokes, and to acquire index coefficients corresponding to respective strokes according to word orders corresponding to respective strokes;

a grouping number calculation module adapted to calculate an index grouping number corresponding to the stroke path according to the index codes and the index coefficients of respective strokes.

Preferably, strokes in the stork input mode comprise: horizontal, vertical, left-falling, right-falling, turning.

Preferably, the following is further comprised:

a index code determination module adapted to select continuous N nonzero integers in one-to-one correspondence to respective strokes in the stroke input mode, as index codes of respective strokes.

Preferably, the index codes are numerical symbols corresponding to keys where the strokes lie.

Preferably, the index coefficients are determined from a stroke number N and an index level number of the stroke input mode.

Preferably, the following is further comprised:

a word weight adjustment module adapted to, with respect to the matched words, according to word frequencies of the words, adjust presentation weights of the words when being used as the on-screen candidate items.

Preferably, the following is further comprised:

a personalized word weight adjustment module adapted to record personalized words of a user and, according to the recording, to adjust presentation weights of the words when being used as the on-screen candidate items.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

A person skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the stroke input device according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

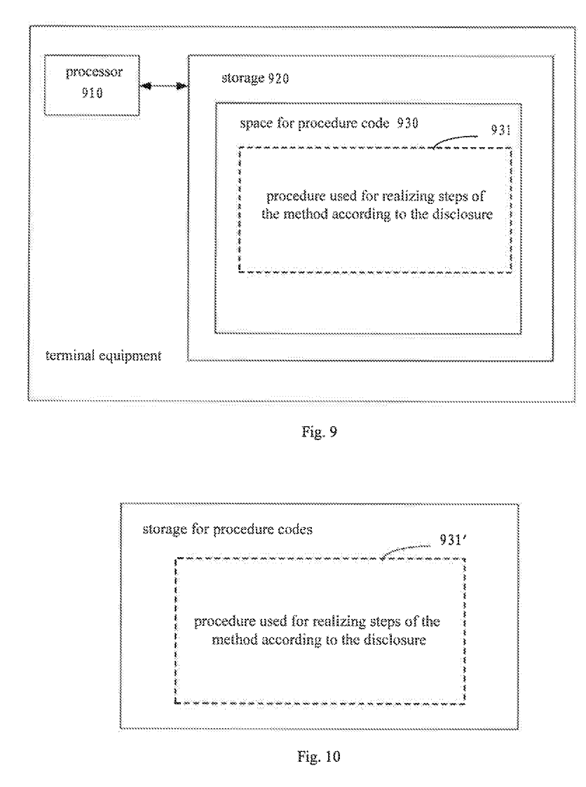

For example, FIG. 9 shows a terminal equipment for a stroke input according to the disclosure. The terminal equipment traditionally comprises a processor 910 and a computer program product in the form of storage 920 or a computer readable medium. The storage 920 can be electronic storage such as flash memory, EEPROM (Electrically Erasable Programmable Read-Only Memory), EPROM, hard disk or ROM, and the like. The storage 920 possesses storage space 930 for carrying out procedure code 931 of any steps of aforesaid method. For example, storage space 930 for procedure code can comprise various procedure codes 931 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 10. The storage cell can possess memory paragraph, storage space like the storage 920 in the computing device in FIG. 9. The procedure code can be compressed in, for example, a proper form. Generally, storage cell comprises computer readable code 931′, i.e. the code can be read by processors such as 910 and the like. When the codes run on a computer device, the computer device will carry out various steps of the method described above.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

1. A stroke input method, comprising:
in a stroke input mode, receiving a stroke sequence inputted by a user;
performing various segmentation operations on the stroke sequence to obtain various stroke paths;
with respect to each stroke path, calculating an index grouping number corresponding to the stroke path according to index codes and corresponding word orders respectively corresponding to respective strokes; and
according to the index grouping number, performing matching for the stroke path with respective words stored under the index grouping number in a lexicon, and using matched words as on-screen candidate items; wherein, the respective words in the lexicon are stored under corresponding index grouping numbers according to index grouping numbers to which the words belong that are calculated according to index codes corresponding to strokes of the respective words.

2. The method according to claim 1, wherein, storing the respective words in the lexicon under corresponding index grouping numbers according to index grouping numbers to which the words belong that are calculated according to index codes corresponding to strokes of the respective words comprises:
with respect to each word in the lexicon, extracting first two strokes of each character of first two characters to obtain a stroke path;
calculating an index grouping number corresponding to the stroke path according to index codes and corresponding word orders respectively corresponding to respective strokes, to determine the index grouping number to which the word belongs;
storing the respective words in the lexicon according to corresponding index grouping numbers.

3. The method according to claim 2, wherein, performing various segmentation operations on the stroke sequence to obtain various stroke paths comprises:
performing various segmentation operations in two-segment form on the stroke sequence to obtain corresponding two-word stroke paths.

4. The method according to claim 1, wherein, calculating an index grouping number corresponding to the stroke path according to index codes and corresponding word orders respectively corresponding to respective strokes comprises:
acquiring index codes of respective strokes, and acquiring index coefficients corresponding to respective strokes according to word orders corresponding to respective strokes;
calculating an index grouping number corresponding to the stroke path according to the index codes and the index coefficients of respective strokes.

5-8. (canceled)

9. The method according to claim 1, further comprising:
with respect to the matched words, according to word frequencies of the words, adjusting presentation weights of the words when being used as the on-screen candidate items.

10. The method according to claim 1, further comprising:
recording personalized words of a user and, according to the recording, adjusting presentation weights of the words when being used as the on-screen candidate items.

11. A stroke input device, comprising:
one or more processors; and
a memory;
wherein one or more programs are stored in the memory, and when executed by the one or more processors, the one or more programs cause the one or more processors to:
in a stroke input mode, receive stroke sequence inputted by a user;
perform various segmentation operations on the stroke sequence to obtain various stroke paths;
with respect to each stroke path, calculate an index grouping number corresponding to the stroke path according to index codes and corresponding word orders respectively corresponding to respective strokes; and
according to the index grouping number, perform matching for the stroke path with respective words stored under the index grouping number in a lexicon, and use matched words as on-screen candidate items; wherein, the respective words in the lexicon are stored under corresponding index grouping numbers according to index grouping numbers to which the words belong that are calculated according to index codes corresponding to strokes of the respective words.

12. The device according to claim 11, the one or more processors are further caused to:
store the respective words in the lexicon under corresponding index grouping numbers according to index grouping numbers to which the words belong that are calculated according to index codes corresponding to strokes of the respective word; specifically comprising:
with respect to each word in the lexicon, extract first two strokes of each character of first two characters to obtain a stroke path;
calculate an index grouping number corresponding to the stroke path according to index codes and corresponding word orders respectively corresponding to respective strokes, to determine the index grouping number to which the word belongs;
store the respective words in the lexicon according to corresponding index grouping numbers.

13. The device according to claim 12, wherein, the one or more processors are further caused to the:
perform various segmentation operations in two-segment form on the stroke sequence to obtain corresponding two-word stroke paths.

14. The device according to claim 11, wherein, the one or more processors are further caused to the:
acquire index codes of respective strokes, and to acquire index coefficients corresponding to respective strokes according to word orders corresponding to respective strokes;
calculate an index grouping number corresponding to the stroke path according to the index codes and the index coefficients of respective strokes.

15-18. (canceled)

19. The device according to claim 11, the one or more processors are further caused to:
a word weight adjustment module adapted to, with respect to the matched words, according to word frequencies of the words, adjust presentation weights of the words when being used as the on-screen candidate items.

20. The device according to claim 11, the one or more processors are further caused to:
record personalized words of a user and, according to the recording, to adjust presentation weights of the words when being used as the on-screen candidate items.

21. A stroke input system, comprising:
a cloud server and a client;
the client comprising:
a stroke sequence receiving module adapted to, in a stroke input mode, receive stroke sequence inputted by a user;
a stroke sequence uploading module adapted to upload the stroke sequence to the cloud server;
a candidate item generation module adapted to use received words as on-screen candidate items;
the cloud server comprising:
a lexicon grouping module adapted to store the respective words in the lexicon under corresponding index grouping numbers according to index grouping numbers to which the words belong that are calculated according to index codes corresponding to strokes of the respective word;
a stroke sequence segmentation module adapted to perform various segmentation operations on the stroke sequence to obtain various stroke paths;
a stroke index grouping calculation module adapted to, with respect to each stroke path, calculate an index grouping number corresponding to the stroke path according to index codes and corresponding word orders respectively corresponding to respective strokes;
a stroke path matching module adapted to, according to the index grouping number, perform matching for the stroke path with respective words stored under the index grouping number in a lexicon, and return matched words to the client.

22. The system according to claim 21, wherein the lexicon grouping module comprises:
a stroke extraction module adapted to, with respect to each word in the lexicon, extract first two strokes of each character of first two characters to obtain a stroke path;
a word index grouping determination module adapted to calculate an index grouping number corresponding to the stroke path according to index codes and corresponding word orders respectively corresponding to respective strokes, to determine the index grouping number to which the word belongs;
a grouping storage module adapted to store the respective words in the lexicon according to corresponding index grouping numbers.

23. The system according to claim 21, wherein the stroke sequence segmentation module comprises:
a two-segment segmentation module adapted to perform various segmentation operations in two-segment form on the stroke sequence to obtain corresponding two-word stroke paths.

24. The device according to claim 21, wherein, the stroke index grouping calculation module or the word index grouping determination module comprises:
a parameter extraction module adapted to acquire index codes of respective strokes, and to acquire index coefficients corresponding to respective strokes according to word orders corresponding to respective strokes; and
a grouping number calculation module adapted to calculate an index grouping number corresponding to the stroke path according to the index codes and the index coefficients of respective strokes.

25-28. (canceled)

29. The device according to claim 21, further comprising:
a word weight adjustment module adapted to, with respect to the matched words, according to word frequencies of the words, adjust presentation weights of the words when being used as the on-screen candidate items.

30. The device according to claim 21, further comprising:
a personalized word weight adjustment module adapted to record personalized words of a user and, according to the recording, to adjust presentation weights of the words when being used as the on-screen candidate items.

31-32. (canceled)
